(19) United States
(12) Patent Application Publication
(10) Pub. No.: US 2010/0056394 A1
(43) Pub. Date: Mar. 4, 2010

(54) Mini Bio-Reactor

(75) Inventors: Yaw-Jen Chang, Tao-Yuan (TW); Cheng-Hao Chang, Tao-Yuan (TW)

Correspondence Address: WPAT, PC;INTELLECTUAL PROPERTY ATTORNEYS, 7225 BEVERLY ST., ANNANDALE, VA, 22003, US

(73) Assignee: CHUNG YUAN CHRISTIAN UNIVERSITY, Tao-Yuan (TW)

(21) Appl. No.: 12/204,273

(22) Filed: Sep. 4, 2008

(51) Int. Cl. C40B 40/02; B01J 19/00; G05D 22/00; C40B 40/10; B01J 19/10; C40B 40/08; G05D 23/00

(52) U.S. Cl. 506/14; 422/187; 422/105; 422/68.1; 506/17; 506/18; 422/128

(57) ABSTRACT

The present invention discloses a bio-reaction module, the so called mini bio-reactor, for providing a stable environment for the hybridization or immuno-reaction on biochips with constant temperature and humidity. Moreover, the mini bio-reactor can be a tool for studying the bio-reaction mechanism. Any variations in bio-reaction mechanism and environmental factors may affect experiment outcomes. Hence, when bulky equipment is miniaturized into a module system, the researchers can utilize a mini bio-reactor to perform bio-experiments or reactors in series connection to perform batch experiments. The structure design of mini reactor is able to promote better reaction efficiency and to shorten reaction time for a variety of bio experiments. Hence what is developed is an automatic, handy and inexpensive device for bio researches with high sensitivity and reliability.

### BACKGROUND OF THE INVENTION

1. Field of the Invention

The present invention is generally related to a bio-reactor, and more particularly to a mini bio-reactor.

2. Description of the Prior Art

A bio-reactor is defined as “bio-catalysis reaction equipment.” Most of the bio-reactors are large sized ovens. They occupy a lot of space, and cost a lot to fabricate. The ovens are easy to cause the change of temperature gradient, and they need more energy to reach the constant temperature and most of them have no humidity controller.

In addition, most of the conventional bio-reactors have no vibrator, wherein the vibrator is increasing the liquid perturbation of the biochips and decreasing the concentration gradient which influences the experiments outcomes.

### SUMMARY OF THE INVENTION

According to the background of this application, a mini bio-reactor is developed and disclosed.

One purpose of the application is to disclose the structure design of mini reactor to promote easier operation and small power consumption. In addition, it can cooperate with the control module and the control software to put the bio-processes programmable.

Another purpose of the application is to disclose a temperature controller, a humidity generator and a vibrator in the mini bio-reactor. It can enhance the effect of molecule interaction with high sensitivity and reliability.

### BRIEF DESCRIPTION OF THE DRAWINGS

FIG. 1 is a schematic diagram of the mini-bioreactor according to the first embodiment of the present invention;

FIG. 2A is a schematic diagram of the mini-bioreactor according to the second embodiment of the present invention;

FIG. 2B is a schematic diagram of the humidity generator according to the example of second embodiment of the present invention;

FIG. 3 is a decomposition diagram of the mini-bioreactor according to the second embodiment of the present invention; and

FIG. 4 is a schematic diagram of the mini-bioreactor according to the second embodiment of the present invention.

### DESCRIPTION OF THE PREFERRED EMBODIMENTS

What is probed into the invention is a mini-bioreactor. Detail descriptions of the structure and elements will be provided as followed in order to make the invention thoroughly understood. The application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail as followed. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

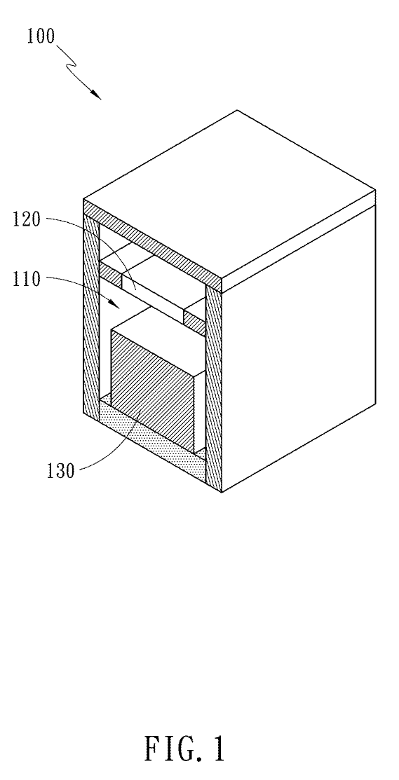

As shown in FIG. 1, a first embodiment of the present application discloses a mini bio-reactor 100, comprising a reaction chamber 110, and a vibrator 120. The above-mentioned reaction chamber 110 is used for biochemical reactions. The above-mentioned vibrator 120 is installed in the reaction chamber 110 to enhance the biochemical reactions. The reaction chamber 110 comprises a temperature and humidity controller 130 to control the temperature and humidity in the reaction chamber 110 to provide constant temperature and humidity. The volume of above-mentioned mini bio-reactor 100 is less than or equal to 40 cubic centimeter. The mini bio-reactor 100 is formed with single module or multi-module in series connection, and the mini bio-reactor 100 is formed with multi-module for batch experiments. The vibrator 120 is a piezoelectric buzzer or other agitating elements.

The mini bio-reactor can be applied to the process of hybridization and immuno-reaction on the biochip. The biochip can be classified as lab-on-a-chip and microarray chip. The biochip integrates the laboratory operations and reactions into a chip. The biochip comprises a silica substrate, or a glass substrate, or polymer substrate. On the substrate micro flow channels, micro reactors and reagents are formed and included by microelectromechanical systems and microfluidic techniques, to perform sample handling, reaction or analysis. The biochip is classified into three types by its functions, which is sample preparation biochip, reaction biochip, and analysis biochip.

The microarray chip consists of a lot of microscopic spots of DNA oligonculeotides arrayed on the block of biochip. Through the DNA hybridization or combination of different proteins, the sample can be analyzed or tested. The microarray chip is classified by its tested objects gene chip, protein chip, tissue chip, and cell chip.

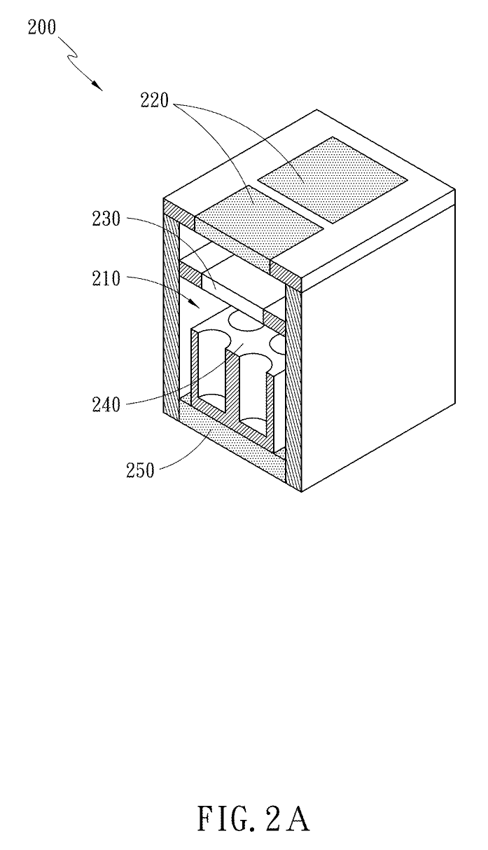

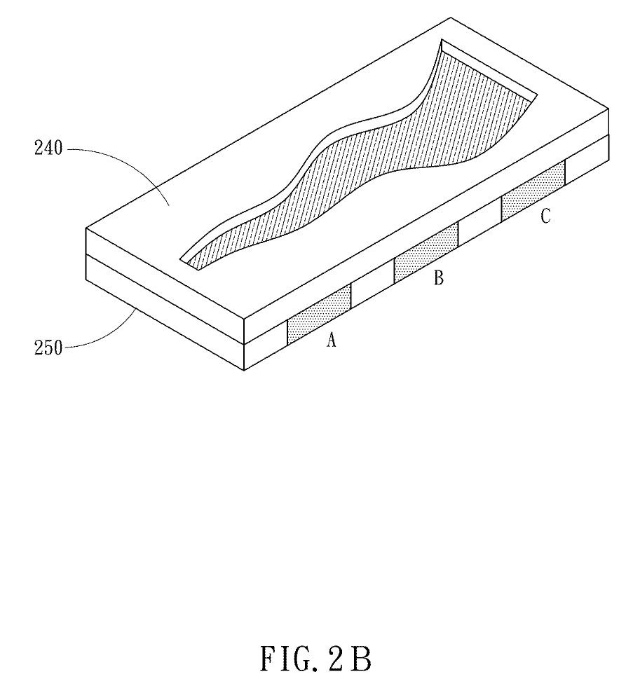

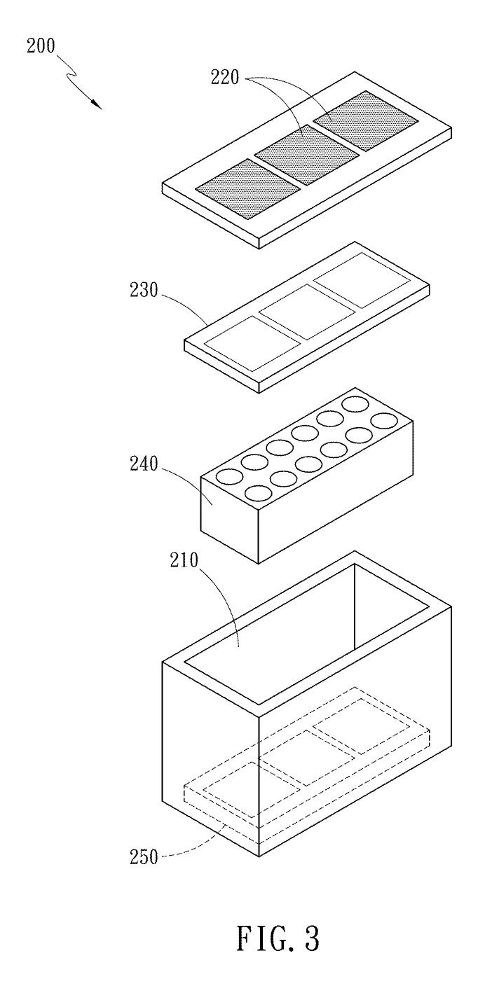

As shown in FIG. 2A and FIG. 3, a second embodiment of the present application discloses a mini bio-reactor 200, comprising a reaction chamber 210, at least one feedback heater (can be solely a top feedback heater 220, or solely a bottom feedback heater 250, or much preferred both top/bottom feedback heaters 220/250), a vibrator 230, and a humidity generator 240. The above-mentioned reaction chamber 210 is used for biochemical reactions. The vibrator 230 is installed in the reaction chamber 210 to enhancing the biochemical reactions. A humidity generator 240 installed at the bottom of the reaction chamber 210. The volume of the mini bio-reactor 200 is less than 40 cubic centimeter. The mini bio-reactor 200 is formed of single module or multi-module in series connection. The mini bio-reactor 200 is formed with multi-module providing a base of numerous experimental testing. The vibrator 230 can be a piezoelectric buzzer or other tremble element. The feedback heaters can comprise one or plurality of thermoelectric cooling elements. The bottom feedback heater is preferred installed under the humidity generator 240, and the top feedback heater 220 is preferred installed at the top of the reaction chamber In a preferred example of this embodiment, the bottom feedback heater 250 having multi heating zones, all of the heating zones being switched on/off to start/stop universally heating the reaction chamber, or some heating zones being switched on while the rest of the heating zones being switched off to locally heating the reaction chamber and adjust the humidity inside the reaction chamber. The humidity generator 240 is selected from the group consisting one of the following: warm air humidifier and ultrasonic humidifier. The warm air humidifier comprises a container selected from the group consisting one of the following: water storage tank and microchannel chip. The feedback heaters(220; 250) control the quantity of water vapor at constant temperature and humidity in the reaction chamber 210. The mini bio-reactor 200 can further comprises a chip holder for supporting at least one biochip above the vibrator. In another preferred example of this embodiment, the mini bio-reactor 200 comprises a fan device to maintain constant temperature in the reaction chamber 210.

As shown in FIG. 2B, the humidity generator 240 comprises a container being a microchannel chip, and the bottom feedback heater 250 controls the quantity of water vapor. The bottom heater 250 comprises multi heating zones A, B, and C and three heating zones can be separately or simultaneously operated to provide specific humidity in the reaction chamber 210.

The mini bio-reactor can be applied to the process of hybridization and immuno-reaction on the biochip. The biochip can be classified as lab-on-a-chip and microarray chip. The lab-on-a-chip biochip is further classified as sample preparation biochip, reaction biochip, and analysis biochip. The microarray chip is classified as gene chip, protein chip, tissue chip, and cell chip.

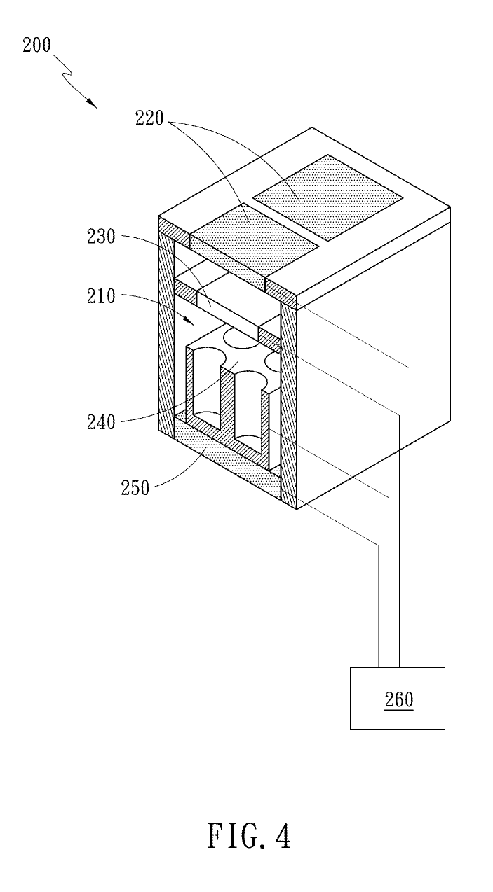

As shown in FIG. 4, the mini bio-reactor comprise a control module 260, and the control module 260 electrically coupled with the top feedback heater 220, the bottom back heater 250, the humidity generator 240, and the vibrator 230. The control module 260 controls the top feedback heater 220 and the bottom feed back heater 250 to provide constant temperature and humidity in the reaction chamber. The control module controls frequency of the vibrator to enhance the molecular interaction and speed up biochemical reaction process through wave propagation of the liquid from the vibrator.

Other modifications and variations are possibly developed in light of the above demonstrations. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A mini bio-reactor, comprising:
a reaction chamber for biochemical reactions; and
a vibrator installed in said reaction chamber to enhance the effect of biochemical reactions.

2. The mini bio-reactor according to claim 1, further comprising a temperature and humidity feedback controller to control the temperature and humidity in said reaction chamber.

3. The mini bio-reactor according to claim 1, wherein said mini bio-reactor is formed of single module or multi-module in series connection.

4. The mini bio-reactor according to claim 1, wherein said vibrator is a piezoelectric buzzer or other tremble element.

5. The mini bio-reactor according to claim 1, wherein said mini bio-reactor is used for biochip.

6. The mini bio-reactor according to claim 5, wherein said biochip is a lab-on-a-chip, wherein said lab-on-a-chip is selected from the group consisting one of the following: sample preparation biochip, reaction biochip, and analysis biochip.

7. The mini bio-reactor according to claim 5, wherein said biochip is a microarray biochip, wherein said microarray biochip is selected from the group consisting one of the following: gene chip, protein chip, tissue chip, and cell chip.

8. A mini bio-reactor, comprising:
a reaction chamber for biochemical reactions;
a feedback heater for heating said reaction chamber;
a vibrator installed in said reaction chamber to enhance the effect of biochemical reactions; and
a humidity generator installed at the bottom of said reaction chamber.

9. The mini bio-reactor according to claim 8, wherein said feedback heater comprises a thermoelectric cooling element.

10. The mini bio-reactor according to claim 8, wherein said feedback heater is installed under said humidity generator.

11. The mini bio-reactor according to claim 8, wherein said feedback heater is installed at the top of said reaction chamber.

12. The mini bio-reactor according to claim 11, further comprising another feedback heater installed under said humidity generator.

13. The mini bio-reactor according to claim 12, wherein the bottom feedback heater comprises a thermoelectric cooling element.

14. The mini bio-reactor according to claim 12, wherein the bottom feedback heater having multi heating zones, all of the heating zones being switched on/off to start/stop universally heating the reaction chamber, or some heating zones being switched on while the rest of the heating zones being switched off to locally heating the reaction chamber and adjust the humidity inside said reaction chamber.

15. The mini bio-reactor according to claim 12, further comprising a control module electrically coupled with the top feedback heater, the bottom feed back heater, said humidity generator, and said vibrator.

16. The mini bio-reactor according to claim 8, wherein said mini bio-reactor comprises a chip holder for supporting one or plurality of biochips, wherein said chip holder is located above said vibrator.

17. The mini bio-reactor according to claim 8, wherein said mini bio-reactor comprises a fan device to maintain constant temperature in said reaction chamber.

18. The mini bio-reactor according to claim 8, wherein said mini bio-reactor is formed of single module or multi-module in series connection.

19. The mini bio-reactor according to claim 8, wherein said vibrator is a piezoelectric buzzer.

20. The mini bio-reactor according to claim 8, wherein said humidity generator is selected from the group consisting one of the following: warm air humidifier and ultrasonic humidifier.

21. The mini bio-reactor according to claim 8, wherein said humidity generator is warm air humidifier and the warm air humidifier comprises a container selected from the group consisting one of the following: water storage tank and microchannel chip.

22. The mini bio-reactor according to claim 8, wherein said mini bio-reactor is used for biochip.

23. The mini bio-reactor according to claim 22, wherein said biochip is a lab-on-a-chip, and wherein lab-on-a-chip is selected from the group consisting one of the following: sample preparation biochip, reaction biochip, and analysis biochip.

24. The mini bio-reactor according to claim 22, wherein said biochip is a microarray biochip, wherein said microarray biochip is selected from the group consisting one of the following: gene chip, protein chip, tissue chip, and cell chip.
